(19) United States
(12) Patent Application Publication
(10) Pub. No.: US 2012/0287607 A1
(43) Pub. Date: Nov. 15, 2012

(54) Operating Device

(75) Inventors: Bettina LEUCHTENBERG, Ehringshausen (DE); Steffen WILDNER, Dieburg (DE)

(73) Assignee: Continental Automotive GmbH, Hannover (DE)

(21) Appl. No.: 13/427,407

(22) Filed: Mar. 22, 2012

(30) Foreign Application Priority Data
Mar. 23, 2011 (DE) 10 2011 014 872.8

(51) Int. Cl. G09F 13/04

(52) U.S. Cl. 362/97.1

(57) ABSTRACT

An operating device for operating different apparatuses and/or functions. The different apparatuses and/or functions are operated by an operating element. A color profile and/or a brightness profile can be represented by an illumination device. The illumination device is arranged adjacent to the operating element.

### BACKGROUND OF THE INVENTION

1. Field of the Invention

The invention relates to an operating device for operating different apparatuses and/or functions, wherein different apparatuses and/or functions are operated successively by an operating element.

2. Description of the Related Art

The prior art discloses operating devices by which an air-conditioning system and a navigation system of a motor vehicle can be operated successively by a single rotary-push controller. In this case, a display device is known with which the operator can discern which apparatus or which function said operator can currently operate by the rotary controller. Such a configuration has the disadvantage that the display device can be far away from the actual operating element, such that an assignment of the corresponding apparatus and/or of the corresponding operating function is made more difficult.

### SUMMARY OF THE INVENTION

It is an object of one embodiment of the invention to facilitate this assignability such that the driver in a motor vehicle is not distracted unnecessarily when operating the apparatus or the function.

This object is achieved by virtue of the fact that a color profile and/or brightness profile is represented by an illumination device, wherein the illumination device is arranged adjacent to the operating element. What is achieved is that the assignability is significantly facilitated. If the operating element is configured as a touchpad, it is possible to arrange the illumination device very close with respect to the operating element. It can be realized, in particular, by the illumination device being arranged below a surface of the touchpad. As a result, firstly the space required for the operating element is reduced and, furthermore, the assignability is increased further.

If the touchpad has a partly transparent colored surface, the illumination device can be perceived only when it actually emits light. As a result, simpler operation is made possible if only the operating elements that can currently be operated are illuminated. Furthermore, a visually appealing operating device can thus be realized.

If the illumination device has an LED, it has a long life time and can be used without additional maintenance. If the illumination device has a microstructured optical waveguide having changing microstructures, it is possible to realize a brightness profile with only one LED. What is achieved by the changing microstructures is that a varying light intensity of the coupled-out light arises along the optical waveguide given a constant brightness of light source or of the LED. Depending on the constitution of the microstructures, more or less light is coupled out. It is thus possible, for example, to couple out either more and more or less and less light along the optical waveguide, such that a varying brightness profile is presented. If the light intensity of the light source is changed, the brightness profile is changed further. If the illumination device has light emitting diodes of different colors, a color variation is also possible by the different-colored light emitting diodes being driven in such a way that they emit different or else identical light intensities of their respective colors and a large number of different colors can thus be realized.

If the illumination device has a plurality of light emitting diodes of different colors, it is possible to represent a changing color profile. Thus, by way example, a sliding regulator can be realized by a touchpad, below which the different-colored light emitting diodes are arranged, such that during operation, for example of an air-conditioning system, depending on the temperature set, a temperature profile from red to blue is realized by virtue of the corresponding number of red or blue light emitting diodes being driven in accordance with the desired color profile.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The invention is described in greater detail with reference to the figures, in which:

FIG. 1 is a first exemplary embodiment of the operating device according to the invention;

FIG. 2 is a second exemplary embodiment of the operating device according to the invention;

FIG. 3 is a first exemplary embodiment of the illumination device according to the invention;

FIG. 4 is a second exemplary embodiment of the illumination device according to the invention;

FIG. 5 is a third exemplary embodiment of the illumination device according to the invention; and

FIG. 6 is a fourth exemplary embodiment of the illumination device according to the invention.

### DETAILED DESCRIPTION OF THE PRESENTLY PREFERRED EMBODIMENTS

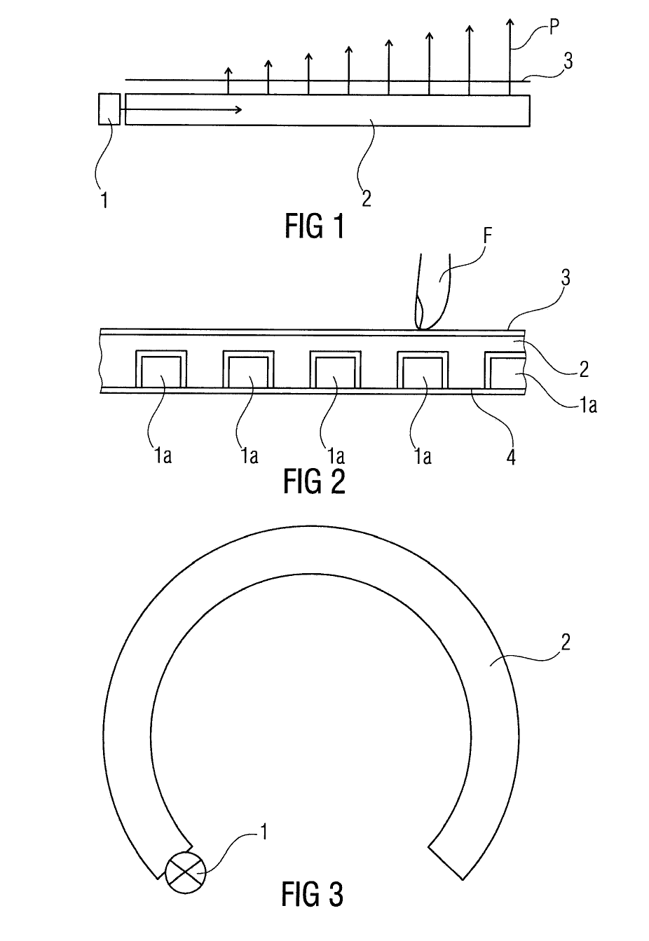

FIG. 1 reveals a light source 1, preferably in the form of an LED, an optical waveguide 2 and a transparent touchpad 3. The optical waveguide 2 has changing microstructures, such that different amounts of light are coupled out, as is illustrated by the arrows, for example, wherein the length of the arrows P is proportional to the quantity of light coupled out. In the exemplary embodiment, the quantity of light coupled out increases at increasing distance from the light emitting diode 1. The surface can also be constituted such that the quantity of light coupled out decreases with increasing distance from the light source 1. In both cases it is possible to realize both a continuous profile, both a continuous increase or decrease in the quantity of light coupled out, and a profile in which, in the course of the optical waveguide, only individual spaced-apart areas in each case couple out different amounts of light.

In FIG. 2 a second exemplary embodiment of the operating device according to the invention comprises multicolor light emitting diodes 1a arranged on a printed circuit board 4. Furthermore, the optical waveguide 2 is shown between the multicolor light emitting diodes 1a. A touchpad 3 produced from a colored transparent material is arranged above the optical waveguide 2. Furthermore, a finger F of an operator is shown. The touchpad 3 can be configured for example in capacitive, resistive, or inductive fashion. If an operator slides their finger F along the surface of the touchpad 3, it is possible for said operator to set the temperature of an air-conditioning system. Depending on the temperature set, by the multicolor light emitting diodes 1a, a color profile is realized that undergoes transition from the blue to the red, wherein the red proportion increases at higher temperatures and the blue proportion increases at lower temperatures set.

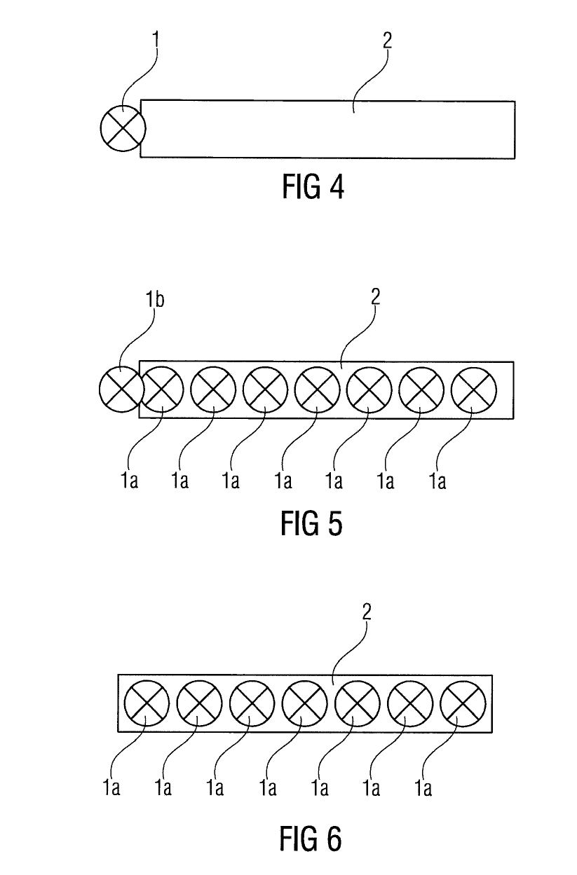

The illumination devices in FIGS. 3 and 4 each have a microstructured optical waveguide 2, wherein the optical waveguide of FIG. 3 follows a partly circular course, and the microstructured optical waveguide 2 in FIG. 4 follows a linear course. The optical waveguide in FIG. 3 can be arranged around a rotary controller for and the optical waveguide in FIG. 4 can serve as a display for a sliding regulator, wherein this sliding regulator can be embodied as a touchpad as in FIG. 1.

In the case of the illumination device in FIG. 5, a microstructured optical waveguide 2 is likewise present as in the case of the illumination device in FIG. 4, which optical waveguide can be illuminated by a white LED 1b and multicolor LEDs 1a. In this case, the light from the white LED 1b can be coupled in laterally, while the light from the multicolor LED's 1a can shine through the optical waveguide. It is thus possible to realize a multicolored color profile whose intensity of the white light can increase or decrease along the optical waveguide, depending on how the microstructures of the optical waveguide are embodied. The color profile can be realized by the different driving of the multicolor LEDs 1a.

The illumination device in FIG. 6 has a plurality of multicolor LEDs 1a, such that, depending on the driving of the individual multicolor LEDs 1a, a color profile with virtually any color and brightness change can be realized.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. An operating device for operating at least one of different apparatuses and different functions, comprising:
an operating element configured to successively operate the at least one of the different apparatuses and the different functions; and
an illumination device arranged adjacent to the operating element,
wherein at least one of a color profile and a brightness profile is represented by the illumination device.

2. The operating device as claimed in claim 1, wherein the operating element is a touchpad.

3. The operating device as claimed in claim 2, wherein the illumination device is arranged below a surface of the touchpad.

4. The operating device as claimed in claim 2, wherein the touchpad is at least one of partially transparent and colored.

5. The operating device as claimed in claim 1, wherein the illumination device comprises at least one LED.

6. The operating device as claimed in claim 5, wherein the illumination device comprises a microstructured optical waveguide with changing microstructures.

7. The operating device as claimed in claim 5, wherein the illumination device has at least two LEDs of different colors.

8. The operating device as claimed in claim 7, wherein the illumination device has a plurality of LEDs of the different colors.

9. The operating device as claimed in claim 3, wherein the touchpad is at least one of partially transparent and colored.

10. The operating device as claimed in claim 6, wherein the illumination device has LEDs of different colors.

11. The operating device as claimed in claim 5, wherein the at least one LED is a multicolor LED.

12. The operating device as claimed in claim 5, wherein the illumination device comprises at least two LEDs and at least one LED is a multicolor LED.

13. The operating device as claimed in claim 6, wherein the microstructured optical waveguide is one of substantially straight and curved.
